(19) United States
(12) Patent Application Publication
(10) Pub. No.: US 2009/0210715 A1
(43) Pub. Date: Aug. 20, 2009

(54) Document verification apparatus, document verification method, and computer product

(75) Inventors: Tetsuya Izu, Kawasaki (JP); Masahiko Takenaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/320,595

(22) Filed: Jan. 29, 2009

Related U.S. Application Data
(63) Continuation of application No. PCT/JP06/15231, filed on Aug. 1, 2006.

(51) Int. Cl. H04L 9/32; G06F 21/24

(52) U.S. Cl. 713/176

(57) ABSTRACT

In verifying a digital document, an input of a digital document is received and the digital document is divided into arbitrary constituent parts. A normal random number or a pseudo random number is assigned to each of the constituent parts according to the order in which the constituent parts appear in the digital document. Thus, verification of the authenticity of a digital document is enabled even when an alteration, such as a change of the order of the partial documents or a copy thereof, has been made to the digital document.

### BACKGROUND OF THE INVENTION

1. Field of the Invention

The present invention relates to of authenticity verification of a digital document.

2. Description of the Related Art

Conventionally, as a technology to verify authenticity of a digital document, a technique using a digital signature has been provided. In this technique of digital signature, a digital signature is assigned to each digital document, and based on the assigned digital signature, the author of the digital document can be authenticated and the authenticity of the digital document can be determined, thereby guaranteeing the authenticity of the digital document.

This technique of digital signature is very useful in terms of preventing tampering by an unauthorized user. However, there has been a problem in terms of practical use of the digital document. For example, if a digital document is edited, the authenticity of the edited digital document is not guaranteed.

For this reason, even when information that should not be disclosed or unnecessary information is included in a digital document, such information cannot be deleted from the document, thereby significantly reducing usability for users. Accordingly, a technique that enables editing of a digital document and protection of the digital document from tampering by an unauthorized user has been demanded.

For example, such a technique has been provided in which a digital document is divided into partial documents, for each partial document, disclosure or non-disclosure is determined, and any partial document determined not to be disclosed is blacked out (see for example, Kunihiko Miyazaki, Mitsuru Iwamura, Tsutomu Matsumoto, Ryoichi Sasaki, Hiroshi Yoshiura, Satoru Tezuka, and Hideki Imai, “A Digital Document Sanitizing Scheme with Disclosure Condition Control”, Preliminary Drafts of the 2004 Symposium on Cryptography and Information Security, the Institute of Electronics, Information and Communication Engineers). By this technique, completeness of a disclosed part and concealment of a not disclosed part are guaranteed.

Moreover, a technique is provided in which a digital document is divided into partial documents, and a digital signature is assigned to each partial document (for example, Japanese Patent Laid-Open Publication No. 2006-60722). For each partial document, disclosure or non-disclosure is determined, and any partial document determined not to be disclosed is deleted. Thus, completeness of disclosed parts in a digital document is guaranteed.

FIG. 16 is a schematic of an example of a conventional digital signature technology. As depicted in FIG. 16, an original document 1600 is divided into partial documents (for example, “Taro Suzuki”), and a digital signature is given to each partial document.

A sanitized document 1601 is a document that has been sanitized by blacking out, according to the technique disclosed in “A Digital Document Sanitizing Scheme with Disclosure Condition Control”, Proceedings of the 2004 Symposium on Cryptography and Information Security, Vol. 1, Jan. 27 to 30, 2004, a partial document that includes confidential content in the original document 1600.

However, in this conventional technique, even if a part specified not to be disclosed is blacked out, the length of the blacked out part can be estimated. Therefore, there is a possibility that the number of characters in the blacked out partial document could be estimated from the length, and it has been a problem that concealment cannot be guaranteed.

Specifically, for example, if the sanitized document 1601 is open to the public, even though specific ages cannot be identified, it can be inferred that in addition to “Jiro Suzuki, five years old”, the sanitized document 1601 includes the description of three other members of this family, who are each six years old or older. Thus, even if a partial document that includes confidential content is blacked out, concealment cannot be completely guaranteed.

Moreover, in the conventional technique described in Japanese Patent Laid-Open Publication No. 2006-60722, if completeness of each partial document that constitutes a digital document has been guaranteed by a digital signature given thereto, the digital document is recognized as a genuine document. Therefore, even if the order of partial documents constituting the digital document is changed or a copy thereof is made, the digital document is recognized as a genuine document.

More specifically, for example, an extraction document 1602 depicted in FIG. 16 includes a partial document that includes descriptions, “Taro Suzuki” and “35 years old”, which are extracted from the original document. Because authenticity is verified based on a digital signature given to each partial document in the conventional technique above, the extraction document 1602 is determined as genuine.

However, the age (38) of “Taro Suzuki” described in the original document 1600 and the age (35) of “Taro Suzuki” in the extraction document 1602 are not consistent. In other words, the extraction document 1602 is a tampered digital document, not a genuine digital document. As described, even if an alteration is made in the contents (secret change of name or age) of the original document 1600, the extraction document 1602 is recognized as a genuine document.

### SUMMARY OF THE INVENTION

It is an object of the present invention to at least solve the above problems in the conventional technologies.

A computer-readable recording medium according to another aspect of the present invention stores therein a computer program that causes a computer to execute receiving an input of a first digital document; dividing arbitrarily the first digital document into constituent parts; and assigning a random number to each of the constituent parts according to an order in which the constituent parts appear in the first digital document, the random number being a normal random number or a pseudo random number.

A document verifying method according to another aspect of the present invention includes receiving an input of a digital document; dividing arbitrarily the digital document into constituent parts; and assigning a random number to each of the constituent parts according to an order in which the constituent parts appear in the digital document, the random number being a normal random number or a pseudo random number.

A document verifying apparatus according to still another aspect of the present invention includes a receiving unit that receives an input of a digital document; a dividing unit that arbitrarily divides the digital document into constituent parts; and an assigning unit that assigns a random number to each of the constituent parts according to an order in which the constituent parts appear in the digital document, the random number being a normal random number or a pseudo random number.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a system configuration diagram of a digital document disclosure system according to a first embodiment;

FIG. 2 is a block diagram of the document verification apparatus according to the first embodiment;

FIG. 3 is a block diagram of a document search apparatus according to the first embodiment;

FIG. 4 is a schematic of an example of an original document to which a digital signature has been added;

FIG. 5 is a flowchart of digital signature creating processing performed by the document verification apparatus according to the first embodiment;

FIG. 6 is a flowchart of digital document extraction processing performed by the document verification apparatus according to the first embodiment;

FIG. 7 is a schematic of an example in which a partial document is extracted from an original document by the digital document extraction processing;

FIG. 8 is a schematic of an example of a forged extraction document;

FIG. 9 is a schematic of an example when a change of the order in which the partial documents appear and copying are performed;

FIG. 10 is a flowchart of digital document verification processing performed by the document verification apparatus according to the first embodiment;

FIG. 11 is a flowchart of digital signature creating processing performed by the document verification apparatus according to the second embodiment;

FIG. 12 is a flowchart of digital document extraction processing performed by the document verification apparatus according to the second embodiment;

FIG. 13 is a flowchart of digital document verification processing performed by the document verification apparatus according to the second embodiment;

FIG. 14 is a flowchart of digital document extraction processing performed by the document verification apparatus according to the third embodiment;

FIG. 15 is a schematic of an example of an original document and an extraction document in which a partial document to be forcibly disclosed is set; and

FIG. 16 is a schematic of an example of a conventional digital signature technology.

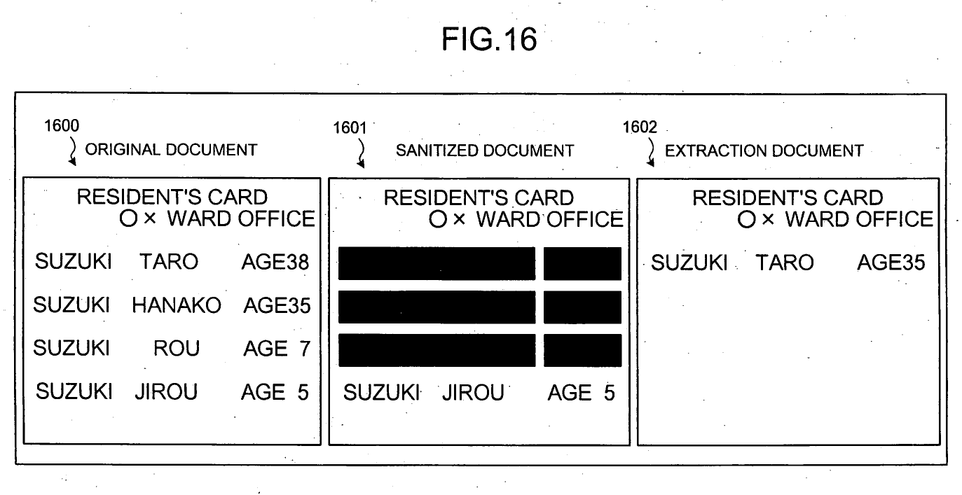

### DETAILED DESCRIPTION OF THE PREFERRED EMBODIMENTS

Referring to the accompanying drawings, exemplary embodiments according to the present invention are explained in detail below.

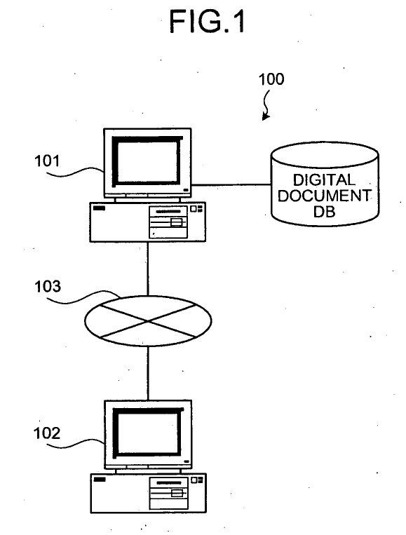

FIG. 1 is a system configuration diagram of a digital document disclosure system according to a first embodiment.

As depicted in FIG. 1, a digital document disclosure system 100 includes a document verification apparatus 101 that is used by a user who discloses information and a document verification apparatus 102 that is used by a user who requests disclosure of information. The document verification apparatus 101 and document verification apparatus 102 are connected through a network 103.

A digital document that is disclosed in the digital document disclosure system 100 is, for example, a digital grade transcript issued by an educational institution or a digital transcript of a family register issued by an administrative body and is highly confidential personal information. The digital document disclosure system 100 can guarantee concealment of such personal information and verify authenticity of personal information that has been tampered with.

The document verification apparatus 101 can create a digital grade transcript or a digital transcript of a family register to be disclosed information. In addition, the document verification apparatus 101 processes the created digital document (for example, a digital grade transcript or a digital transcript of a family register) so that authenticity thereof can be verified, and stored in a digital document database (DB).

Hereinafter, a document that is to be processed so that the authenticity thereof can be verified in the document verification apparatus 101 is referred to as an original document. Specific processing of a digital document and specific contents to be stored in the digital document DB are explained later.

Moreover the document verification apparatus 101 searches the digital document DB for a corresponding digital document (digital document whose authenticity can be verified) when a request signal indicating a request for information disclosure is received from the document verification apparatus 102. The document verification apparatus 101 then sends a retrieved digital document to the document verification apparatus 102 as a disclosure document. Further, the document verification apparatus 101 can delete a document that includes confidential content in the retrieved document when sending a search result (searched digital document) to the document verification apparatus 102.

A document that includes confidential content is, for example, information that should not be disclosed from a view point of personal information protection, information associated with national security, or the like. A user of the document verification apparatus 101 can delete information that is not to be disclosed by designating any information in the original document. In this case, the document verification apparatus 101 creates a disclosure document (extraction document) by deleting information not to be disclosed from the original document, and sends the created disclosure document to the document verification apparatus 102.

The document verification apparatus 102 can send a request signal indicating a request for information disclosure to the document verification apparatus 101. The document verification apparatus 102 receives a disclosure document from the document verification apparatus 101, as a result of sending the request signal. The document verification apparatus 102 can verify authenticity of the received disclosure document. In other words, excluding any information that has been deleted in view of information protection, the document verification apparatus 102 on the information requesting side can verify whether the disclosed information is authentic.

A user of the document verification apparatus 102 can acquire only desired information by designating any information in the disclosure document. Thus, the user that requests information disclosure can arbitrarily change the content of a disclosure document.

For example, a user who is a student at an educational institution makes a request for disclosure of a digital grade transcript to the document verification apparatus 101 provided at the educational institution. As a result, the user can obtain the digital grade transcript that the user has requested, and change the content of the digital grade transcript arbitrarily. For example, a fraudulent change can be made, such as deletion, from the digital grade transcript, of content related to a course for which a poor grade was received or the copying of a high grade received for one course to another for which a poor grade was received.

As described, the authenticity of information that has been arbitrarily changed by a user can be verified by a document verification apparatus (for example, the document verification apparatuses 101 and 102), and verification of whether an unauthorized alteration has been made is possible.

In this example, an apparatus used by a user on the side of creating personal information such as a digital grade transcript and a digital transcript of a family register is the document verification apparatus 101, and an apparatus used by a user on the side of requesting information disclosure is the document verification apparatus 102. Alternately, the document verification apparatus 102 can create information to disclose to a user of the document verification apparatus 101.

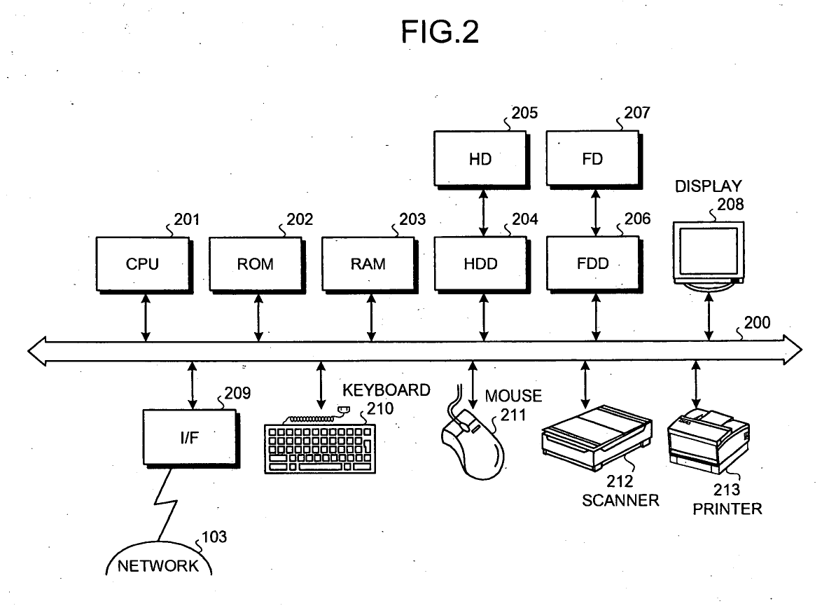

FIG. 2 is a block diagram of the document verification apparatus according to the first embodiment. As depicted in FIG. 2, a document verification apparatus 200 includes a central processing unit (CPU) 201, a read only memory (ROM) 202, a random access memory (RAM) 203, a hard disc drive (HDD) 204, a hard disc (HD) 205, a flexible disc drive (FDD) 206, a flexible disc (FD) 207, a display 208, an interface (I/F) 209, a keyboard 210, a mouse 211, a scanner 212, and a printer 213, each respectively connected through a bus 200.

The CPU 201 governs control of the document verification apparatus (e.g., the document verification apparatus 101, 102). The ROM 202 stores therein various programs such as a boot program and a document verification program concerning digital signature creation processing, digital document extraction processing, and digital document verification processing. The RAM 203 is used as a work area of the CPU 201.

The HDD 204 controls the reading/writing of data from/to the HD 205 under the control of the CPU 201. The HD 205 stores therein data written thereto under the control of the HDD 204. In the HD 205, for example, the digital document DB depicted in FIG. 1 is built.

The FDD 206 controls the reading/writing of data from/to the FD 207 under the control of the CPU 201. The FD 207 stores therein the data written thereto under the control of the FDD 206, and allows the document verification apparatus to read the data stored therein.

A removable recording medium may be, besides the FD 107, a compact disk read-only memory (CD-ROM), compact disk-recordable (CD-R), a compact disk-rewritable (CD-RW), a magneto optical disk (MO), a digital versatile disc (DVD), or a memory card. The display 208 displays a cursor, an icon, a tool box, and data such as document, image, and function information. The display 208 may be, for example, a cathode ray tube (CRT), a thin-film-transistor (TFT) liquid crystal display, or a plasma display.

The I/F 209 is connected to a network 103 such as Internet through a telecommunication line and is connected to other devices by way of the network 103. The I/F 209 serves as an interface between the network 103 and the inside of the document verification apparatus, and controls the input and output of data from and to external apparatuses. The I/F 209 may be, for example, a modem or a local area network (LAN) adapter.

The keyboard 210 is equipped with keys for the input of characters, numerals, and various instructions, and data is entered through the keyboard 210. The keyboard 210 may be a touch-panel input pad or a ten-key keypad. The mouse 211 performs cursor movement, range selection, and movement, size change, etc., of a window. The mouse 211 may be a trackball or a joystick provided it has similar functions as a pointing device.

The scanner 212 optically reads an image and takes in the image data into the document verification apparatus. The scanner 212 may have an optical character recognition (OCR) function as well. The printer 213 prints image data and document data. The printer 213 may be, for example, a laser printer or an ink jet printer.

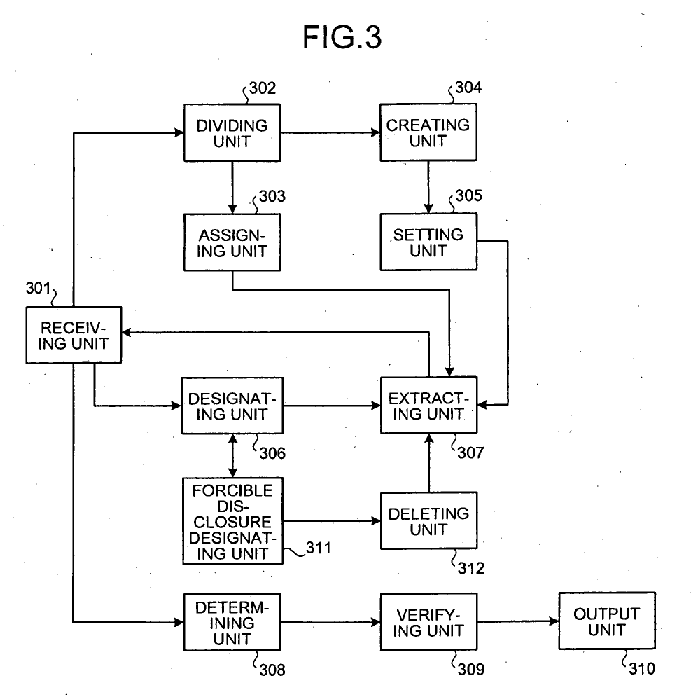

FIG. 3 is a block diagram of a document search apparatus according to the first embodiment. As depicted in FIG. 3, the document search apparatus includes a receiving unit 301, a dividing unit 302, an assigning unit 303, a creating unit 304, a setting unit 305, a designating unit 306, an extracting unit 307, a determining unit 308, a verifying unit 309, a forcible-disclosure designating unit 311, and a deleting unit 312.

The receiving unit 301 receives an input of a digital document. A digital document herein is a general term of documents handled on a computer, and is electronic data that is created by using a document creating application and the like. A digital document includes, for example, highly confidential personal information such as a digital grade transcript and a digital transcript of a family register. A digital document can be created by the document verification apparatus, or by another device. When a digital document is created by another device, the document verification apparatus obtains the document through the network 103 such as the Internet.

The dividing unit 301 divides the digital document that is input through the receiving unit 301 into arbitrary constituent parts. A constituent part can be obtained by dividing the digital data so that each data is 1 byte from the top of the digital document (the top part when the input digital document is read in this example), or by dividing by sentence or word.

Moreover, if a digital document is a document described by an extensible markup language (XML) or the like, the smallest component of the document can be one constituent part.

The assigning unit 303 assigns a normal random number or a pseudo random number (hereinafter, “random number”) to each constituent part sequentially according to position in the digital document divided into the constituent parts by the dividing unit 301. The order in which each constituent part appears is defined by the arrangement of the constituent parts in the digital document. For example, a random number can be assigned to each constituent part in an ascending order or descending order with respect to the order in which the digital document is read by the document verification apparatus.

The normal random number is each element that is included in an irregular sequence. Specifically, a normal random number is generated by using a random physical phenomenon. The pseudo random number indicates each element that is included in such a sequence that looks like an irregular random number sequence even through the sequence is acquired by certain calculation. Specifically, a pseudo random number is a random number that is as difficult as possible to be estimated among numbers generated on a computer, and impartialness of numbers created is enhanced. This pseudo random number can be generated, for example, by using a pseudo random number generator (pseudo random number generating method). The pseudo random number generator is a device that can output such a sequence that a polynomial time calculator cannot recognize as a random number.

The generated random numbers are assigned to the respective constituent parts in ascending order or descending order. For example, according to the order in which the constituent parts appear in a digital document, the random numbers are assigned respectively to the constituent parts so that the value of the random number sequentially increases. A specific method of generating and assigning the random numbers is described later.

Alternately, the assigning unit 303 can assign, to each constituent part obtained by dividing the digital document by the dividing unit 302, a random number (hereinafter, “common random number”) common among the respective constituent parts. The common random number is a random number that is set to be impossible to be estimated for each digital document, and is a value common among all constituent parts constituting the digital document. A common random number is generated by using the above pseudo random number generator, for example.

The creating unit 304 creates a digital signature for each constituent part that is obtained by dividing a digital document by the dividing unit 302. The digital signature is a scheme to perform authentication of data (digital document), or is signature data that is added to a digital document. The digital signature can be implemented by using a public key encryption. Specifically, the digital signature is a technology that is used when a sender wishes to prove that he/she is the sender himself/herself of a digital data when the digital data is to be sent to a person he/she is communicating with.

In other words, the digital signature is to verify an authorized author of a digital document and authenticity of the digital document (not tampered) similarly to a physical signature (seal, etc.). Furthermore, the digital signature can only be created by the author himself/herself, and the authenticity of the digital document can be verified by any user.

To achieve this, for example, the principle of the public key encryption is used. Specifically, only a user having a private key (signature key) can create signature text (digital document to which a digital signature is assigned). Moreover, the public key (verification key) is open so that any user can conduct the verification.

The flow from creation of a digital signature to verification is explained. An author of a digital signature (hereinafter, “sender”) creates a public key and a private key in advance according to the public key encryption. The private key is kept secret by the sender, and only the public key is open to a communication counterpart. The sender, using the private key, creates a digital signature for a digital document the sender wishes to sign.

Next, the sender adds the digital signature to an original digital document to send to the communication counterpart (hereinafter, “receiver”). The receiver receives the original digital document and the digital signature. The receiver then verifies the digital signature with the public key made open by the sender.

The receiver checks whether a value obtained from the original digital document and the public key and a value obtained from the digital signature coincide with each other. When these values coincide with each other, the authenticity of the digital document and the sender are verified. On the other hand, if the values do not coincide with each other, tampering of the digital document and the digital signature can be detected.

The authenticity of the public key (verification key) is required to be guaranteed even though the public key is open. Therefore, a signature can be assigned to the public key by a reliable organization. As a specific method to realize the digital signature, for example, an RSA signature and an efficient digital signature (ESIGN) based on prime factorization, an ElGamal signature and a digital signature algorithm (DSA) based on discrete log, an EC-ElGamal signature and an EC-DSA signature based on elliptic discrete log, and the like can be used.

The creating unit 304 can be configured to create an aggregate digital signature in which digital signatures of respective constituent parts are aggregated. The aggregate digital signature is obtained by putting digital signatures created for respective constituent parts together. Specifically, the aggregate digital signature can be formed by a product of the digital signatures of respective constituent parts, or by a sum of the digital signatures of respective constituent parts, for example.

The setting unit 305 sets a digital signature created by the creating unit 304 for each constituent part to the corresponding constituent part. Specifically, the setting unit 305 respectively correlates and records, in the digital document DB for each constituent part, a digital signature created by the creating unit 304 and the corresponding constituent part.

The designating unit 306 receives designation of a constituent part that constitutes a digital document. Specifically, a user of the document verification apparatus designates an arbitrary constituent part constituting a digital document by operating the keyboard 210 or the mouse 211. To each constituent part constituting a digital document, a random number is assigned, and a corresponding digital signature is set.

The extracting unit 307 extracts the constituent part designated by the designating unit 306 from the digital document. Specifically, the extracting unit 307 extracts the constituent part designated by the designating unit 306 together with the random number assigned to the constituent part. Hereinafter, a digital document that is constituted by an extracted constituent part is referred to as “extraction document”.

Configuration may be such that constituent parts other than the constituent part extracted by the extracting unit 307 in the digital document are deleted together with the random numbers that are assigned to the constituent parts other than the extracted constituent part. In this case, the digital signatures that are set to the constituent parts other than the extracted constituent part are also deleted.

Furthermore, configuration may be such that the digital signatures of the constituent parts other than the extracted constituent part are deleted from the aggregate digital signature created by the creating unit 304. For example, if the aggregate digital signature is formed by a product of digital signatures set to respective constituent parts, the aggregate digital signature is divided by a digital signature set to a constituent part other than the extracted constituent part.

Moreover, the receiving unit 301 can be configured to receive an input of a digital document that is constituted by the constituent part extracted by the extracting unit 307. Specifically, the receiving unit 301 receives an input of an extraction document to be a subject of authenticity verification.

The determining unit 308 determines whether the random numbers assigned to respective constituent parts input through the receiving unit 301 are in accordance with the order in which the respective constituent parts appear in the digital document. Specifically, the determining unit 308 determines whether the random numbers assigned to the respective constituent parts constituting a digital document are in an ascending order or a descending order according to the order in which the respective constituent parts appear in the digital document.

Furthermore, the determining unit 308 can be configured to determine authenticity of each constituent part based on the digital signature set to a constituent part extracted by the extracting unit 307. Specifically, the determining unit 308 performs verification of the digital signature set to the constituent part, and determines whether the verification passes. For example, the determining unit 308 decodes the digital signature set to the constituent part, and determines whether the result of the decoding and the constituent part coincide with each other.

Moreover, the determining unit 308 can be configured to determine whether the common random number assigned to each constituent part by the assigning unit 303 is consistent among the constituent parts extracted by the extracting unit 307.

Furthermore, the determining unit 308 can be configured to determine the authenticity of a digital document constituted by the constituent part extracted by the extracting unit 307, based on the aggregate digital signature created by the creating unit 304. The aggregate digital signature here is the one obtained by deleting digital signatures set to constituent parts other than the constituent part extracted by the extracting unit 307. Specifically, the determining unit 308 determines whether the aggregate digital signature passes verification.

The verifying unit 309 verifies authenticity of the digital document based on a result of the determination made by the determining unit 308. Specifically, the verifying unit 309 verifies the digital document as genuine when the determining unit 308 determines that the random numbers assigned to the respective constituent parts are in accordance with the order in which the respective constituent parts appear in the digital document, for example.

Moreover, the verifying unit 309 can be configured to verify a digital document as genuine when the determining unit 308 determines that each constituent part is genuine. Further, the verifying unit 309 can be configured to verify a digital document as genuine when the common random numbers assigned to respective constituent parts are consistent among arbitrary constituent parts.

The output unit 310 outputs a result of verification performed by the verifying unit 309. Specifically, when a digital document is verified by the verifying unit 309, the output unit 310 outputs a verification result indicating success of the verification. Moreover, when the digital document is not verified by the verifying unit 309, the output unit 310 can output a verification result indicating failure of the verification.

The forcible-disclosure designating unit 311 receives designation of a partial document to be forcibly disclosed from among constituent parts constituting a digital document. The partial document to be forcibly disclosed is a partial document that cannot be deleted and that is forcibly extracted by the extracting unit 307 from the digital document.

The deleting unit 312 deletes the digital signature set to the constituent part designated by the forcible-disclosure designating unit 311. Having the digital signature deleted by the deleting unit 312, the constituent part designated by the forcible-disclosure designating unit 311 becomes in a state in which a digital signature is not set. The determining unit 308 does not make determination on authenticity of the constituent part to which a digital signature is not set.

Functions of the receiving unit 301, the dividing unit 302, the assigning unit 303, the creating unit 304, the setting unit 305, the designating unit 306, the extracting unit 307, the determining unit 308, the verifying unit 309, the output unit 310, the forcible-disclosure designating unit 311, and the deleting unit 312 are implemented, specifically, by causing the CPU 201 to execute a program recorded on a recording medium such as the ROM 202, the RAM 203, and the HD 205 or the I/F 209 depicted in FIG. 2, for example.

Next, procedures of various processing performed by the document verification apparatus are explained. First, digital signature assignment processing at the time of processing a digital document such that authenticity of the digital document can be verified is explained. This digital signature assignment processing specifically is processing performed by an apparatus on the side of disclosing information such as the document verification apparatus 101 depicted in FIG. 1.

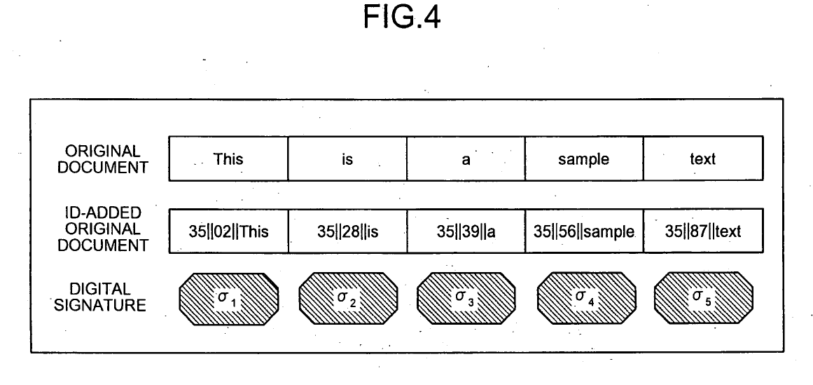

FIG. 4 is a schematic of an example of an original document to which a digital signature has been added. As depicted in FIG. 4, the original document being a digital document is divided into partial documents (each word is a partial document in this example).

To each partial document, an unpredictable document identification (ID) and a partial document ID are added using random numbers. In this example, the original document to which the document ID and the partial document ID are added is referred to as “ID-added original document”.

The document ID is a value set to each original document, and is added to all partial documents constituting a single original document. In this example, “35” commonly added to the respective partial documents is the document ID. The document ID corresponds to the common random number that is assigned to constituent parts constituting a digital document by the assigning unit 303 described above.

Furthermore, the partial document ID takes a different value for each partial document, and is added to each partial document so that values are in an ascending order according to the order in which the partial documents constituting the original document appear. In this example, the partial document IDs are added to the respective partial documents so that the partial document IDs using random numbers are given in an ascending order (“02”→“28”→“39”→“56”→“87”) from a partial document at the left end (“This”) among the partial documents constituting the original document. The partial document ID corresponds to the random number assigned, by the assigning unit 303 described above, to each constituent part according to the order in which the partial documents appear in a digital document.

Further, to each partial document constituting the original document, a digital signature created for each partial document is assigned. In this example, digital signatures σ₁ to σ₅ created for respective partial documents (respective words) are added to corresponding partial documents. Specifically, to the partial document “This”, for example, the digital signature σ₁ is added. The digital signature corresponds to the digital signature created by the creating unit 304 described above for each constituent part constituting a digital document.

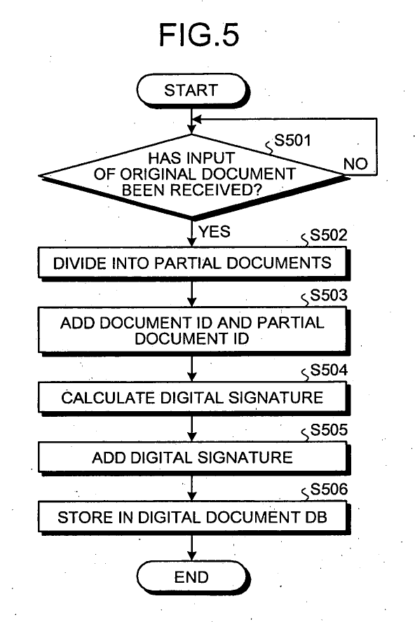

FIG. 5 is a flowchart of the digital signature creating processing performed by the document verification apparatus according to the first embodiment. As depicted in the flowchart in FIG. 5, the document verification apparatus first determines whether an input of an original document has been received (step S501).

The original document includes highly confidential personal information such as a digital grade transcript created by a staff of an educational institution and a digital transcript of a family register created by personnel of an administrative organization. This original document can be created by the document verification apparatus or can be obtained from another device.

Waiting occurs until an original document is input, and when an input of an original document is received (step S501: YES), the input original document is divided into partial documents (step S502). The partial documents are constituent parts that constitute the original document, and can be defined arbitrarily. Specifically, as depicted in FIG. 4, the original document can be divided, as the partial documents, into respective words constituting the original document, for example.

Next, the document ID and the partial document ID are added to each of the partial documents obtained at step S502 (step S503). The document ID is a value set for each original document, and is unpredictably set using a random number. The partial document ID is a value set for each of the partial documents, and is unpredictably set using a random number.

Random numbers set as the document ID and the partial ID are generated using the pseudo random number generator described above or the like. Using the created random numbers, the document ID is added to all of the partial documents constituting the original document, and different partial numbers are added to the respective partial documents in an ascending order.

“Adding the document ID and the partial document ID” can mean that the document ID and the partial document IDs are actually added to the original documents in description, or that each partial document and the document ID and the partial document ID for the corresponding partial document are associated with each other.

An example in which different partial document IDs are added to the respective partial documents in an ascending order (or a descending order) is explained. For example, random numbers generated by the pseudo random number generator are added to the respective partial documents as the partial document IDs. In this case, the creation and the addition of random numbers to the respective partial documents are repeated until the random numbers added to the partial documents are in an ascending order (or descending order).

As another example, random numbers can be generated in advance in a quantity equivalent to the number of the partial documents and sorted so that the random numbers are in an ascending order or descending order for addition to the respective partial documents. In this case, the random numbers can be generated using a hash function that enables generation of random numbers in a fixed length from input original data.

Here, description continues with reference to FIG. 5. A digital signature for each of the partial documents obtained at step S502 is calculated (step S504). As a calculation method for digital signatures, the RSA signature, the ElGamal signature, the DSA signature described above, or the like can be used.

The calculated digital signatures are added to the corresponding partial documents, respectively (step S505). Specifically, the digital signatures calculated for the respective partial documents are set to the corresponding partial documents in a correlated manner, to create a digital document (original document) having a digital signature added thereto.

Finally, the original document to which the digital signature has been added is stored in the digital document DB (step S506), and a series of processing in this flowchart ends. The digital document DB is a database created in a recording medium, such as the HD 205.

In the digital document DB, the document ID and the partial document IDs added at step S503 are stored correlated with the respective partial documents, together with the original document to which a digital signature has been added. Specifically, in the digital document DB, the original document depicted in FIG. 4, the original document to which IDs have been added, and the digital signature that has been added to the original document are stored, for example.

The processes at step S504 and step S505 can be performed with an arbitrary timing provided the processes at step S504 and step S505 are performed after the original document is divided into partial documents at step S502. For example, before adding the document ID and the partial document IDs at step S503, the processes at step S504 and step S505 in the flowchart can be performed.

Thus, verification of authenticity of an extraction document can be performed even when an alteration such as a change in the order of partial documents constituting a digital document or copy thereof is made.

Next, a digital document extraction processing performed by the document verification apparatus is explained. A user of the document verification apparatus can extract only desirable information from a digital document to which a digital signature has been added by the digital signature creating processing described above. To the digital document to which a digital signature is added, a document ID and partial document IDs are added. Specifically, only information that can be disclosed can be extracted from among a public digital document that includes content concerning a national secret or the like.

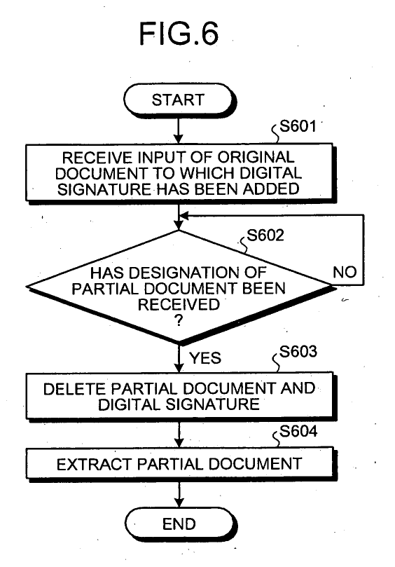

FIG. 6 is a flowchart of the digital document extraction processing performed by the document verification apparatus according to the first embodiment. As depicted in FIG. 6, the document verification apparatus first receives an input of an original document to which a digital signature has been added (step S601).

Next, it is determined whether designation of any partial document constituting the original document has received (step S602). Specifically, the user designates an arbitrary partial document to be extracted from the original document shown on the display 208 by operating the keyboard 210 or the mouse 211, for example.

Waiting occurs until designation of an arbitrary partial document is received, and when the designation is received (step S602: YES), exclusive of the designated partial document, partial documents and the digital signatures added thereto are deleted (step S603). Specifically, the digital signature added to each of the partial documents that are not designated as the extraction document are deleted as well as the partial documents themselves (the document ID and the partial document IDs added thereto) are also deleted.

Finally, the designated partial document is extracted from the original document (step S604), and a series of processing in this flowchart ends.

Thus, an arbitrary partial document can be extracted from an original document by designating an arbitrary partial document in a digital document.

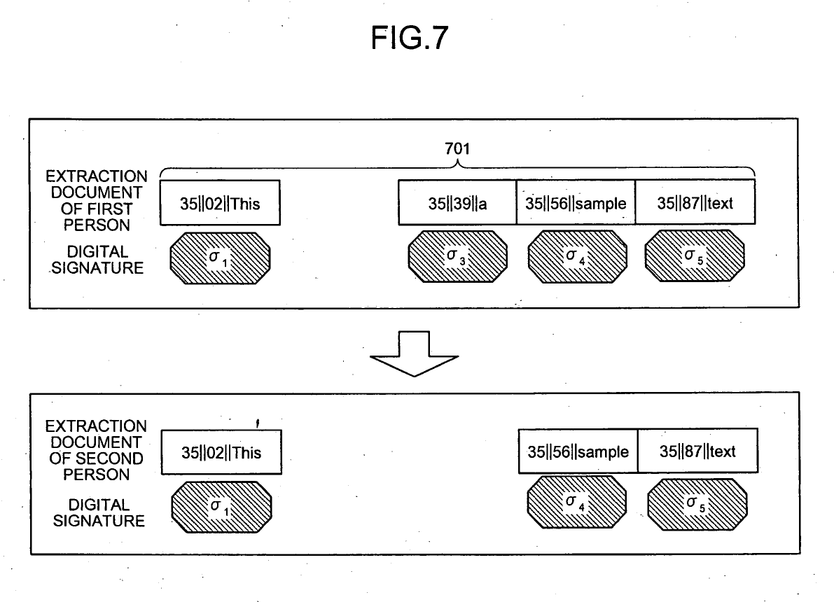

FIG. 7 is a schematic of an example in which a partial document is extracted from an original document by the digital document extraction processing. An example of extraction performed by two users is explained herein.

As depicted in FIG. 7, when a first user designates partial documents other than a partial document “is” as partial documents to be extracted, the partial documents (extraction document 701) other than “is” are extracted from the original document depicted in FIG. 4. In this case, data corresponding to “is” is deleted from the original document to which the ID has been added as depicted in FIG. 4, and the digital signature “σ₂” added to “is” is also deleted.

Subsequently, when a second user designates partial documents other than a partial document “a” as partial documents to be extracted, the partial documents other than “a” are extracted from the extraction document 701. In this case, data corresponding to “a” is deleted from the extraction document 701, and the digital signature “σ₃” added to “a” is also deleted.

In addition to the alteration performed by the digital document extraction processing described above, other alterations such as a change of the order in which partial documents constituting the digital data appear and a copy thereof can be made by each document verification apparatus or a digital document editing apparatus. To detect such an alteration, a document ID and a partial document ID are added to each partial document constituting a digital data.

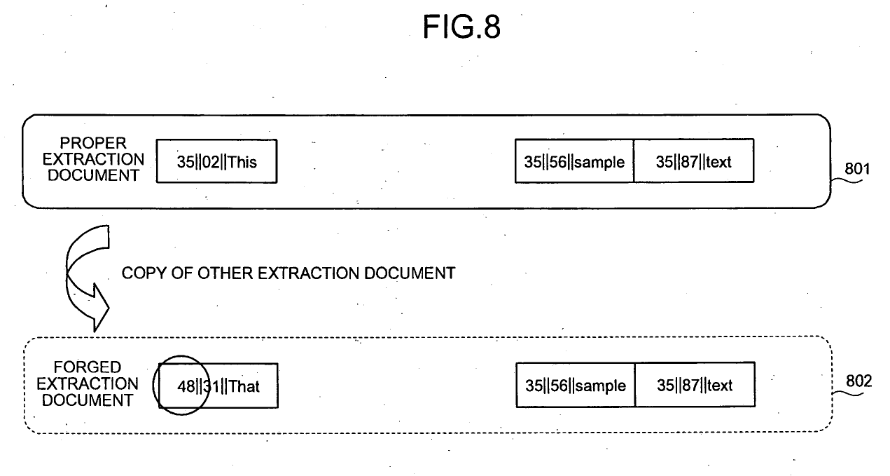

First, the significance of the document ID added at step S503 in the flowchart depicted in FIG. 5 is explained. FIG. 8 is a schematic of an example of a forged extraction document. As depicted in FIG. 8, in the case of an authentic extraction document 801 to which no improper edition (extraction) has been made, the document IDs added to the respective partial documents take a common value. Specifically, “35” added as the document ID is common to all of the partial documents.

On the other hand, in the case of a forged extraction document 802 to which extraction of a partial document is improperly performed by, for example, copying a partial document from another digital document, the document IDs added to the respective partial documents are not consistent. Specifically, a document ID “48” added to “That”, which has been copied from another digital document, is different from a document ID “35” added to other partial documents.

As described, by determining whether the document IDs added to the respective partial documents constituting the extraction document take a common value, authenticity of the extraction document can be verified and a copy of a partial document from another digital document can be detected.

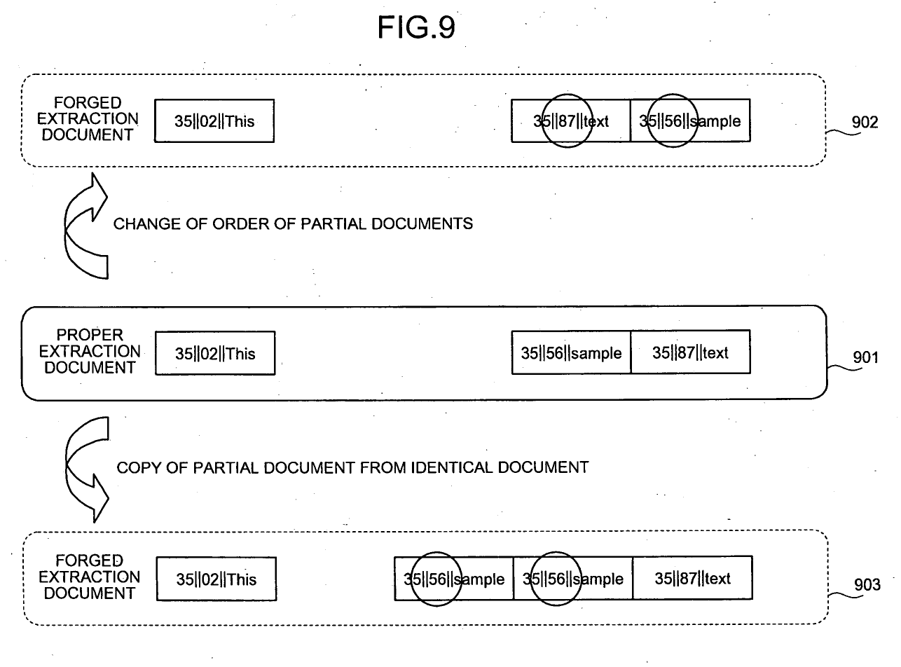

Next, the significance of the partial document ID added at step S503 in the flowchart depicted in FIG. 5 is explained. FIG. 9 is a schematic of an example when a change of the order in which the partial documents appear and copying are performed. An extraction document 901 is a digital document obtained as a result of proper extraction of a partial document from the original document depicted in FIG. 4.

A forged extraction document 902 is a digital document that is created using the extraction document 901, for which proper extraction of a partial document has been performed. Specifically, the forged extraction document 902 is created by changing the order of the partial documents constituting the extraction document 901.

To check the authenticity of this forged extraction document 902, it is determined whether partial document IDs added to the respective partial documents are arranged in an ascending order. In the forged extraction document 902, the order of the partial document IDs added to the respective partial documents is as “02”→“87”→“56”, and is not arranged in an ascending order. Therefore, the forged extraction document 902 can be detected to be a digital document that has been improperly extracted.

Further, a forged extraction document 903 is a digital document that is created using the extraction document 901, for which proper extraction of a partial document has been performed. Specifically, the forged extraction document 903 is created by making a copy of a partial document in the extraction document 901.

To check the authenticity of this forged extraction document 903 also, it is determined whether partial document IDs added to the respective partial documents are arranged in an ascending order. In the forged extraction document 903, the order of the partial document IDs added to the respective partial documents is as “02”→“56”→“56”, and is not arranged in an ascending order. Therefore, the forged extraction document 903 can be detected to be a digital document that has been improperly extracted.

By thus determining whether the partial document IDs added to the respective partial documents constituting an extraction document are arranged in an ascending order, change of the order of partial documents included in the same extraction document and copy thereof can be detected. Even if extraction (deletion) of a partial document is performed, the ascending order of partial document IDs is maintained, and therefore, the detection of change of the order of partial documents and copy thereof is not affected thereby.

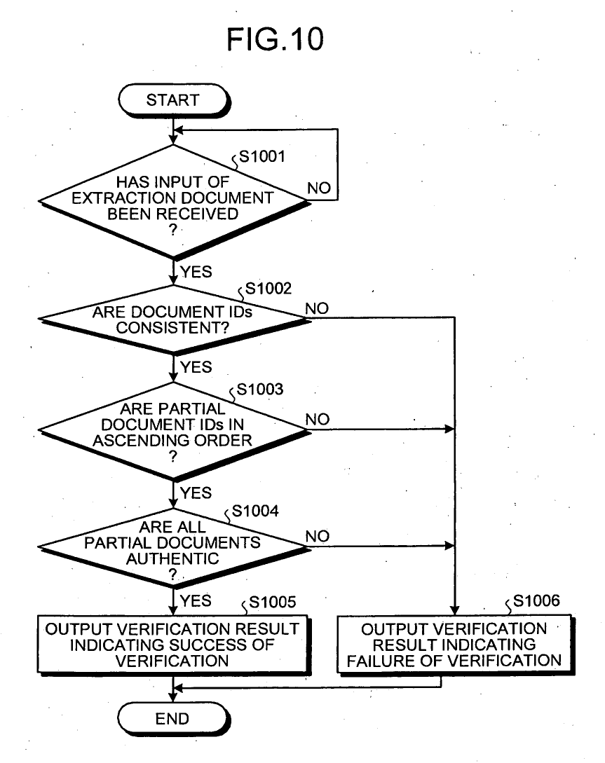

FIG. 10 is a flowchart of digital document verification processing performed by the document verification apparatus according to the first embodiment.

As depicted in FIG. 10, the document verification apparatus first determines whether an input of an extraction document has been received (step S1001). An extraction document is the extraction document extracted by the digital document extraction processing described above. Further, a digital document that has been altered after extraction is also considered here to be an extraction document.

Waiting occurs until an extraction document is input, and when an input is received (step S1001: YES), it is determined whether the document IDs respectively added to the partial documents constituting the extraction document take an identical value (step S1002).

When the document IDs respectively added to the partial documents all take an identical value (step S1002: YES), it is determined whether the partial document IDs respectively added to the partial documents are arranged in ascending order (step S1003). Specifically, it is determined whether the value of the partial document ID added to each partial document increases in the order in which the partial documents constitute the extraction document.

When the partial document IDs respectively added to the partial documents are arranged in ascending order (step S1003: YES), based on the digital signature added to each of the partial documents, authenticity of all of the partial documents constituting the extraction document is determined (step S1004). Specifically, the digital signatures respectively added to the partial documents constituting the extraction document are verified and based on a result of the verification, the authenticity of the extraction document is determined.

When all of the partial documents are verified to be authentic (step S1004: YES), a verification result indicating success of the verification of the extraction document is output (step S1005), and a series of processing in this flowchart ends.

When the document IDs respectively added to the partial documents do not take an identical value (step S1002: NO), a verification result indicating failure of the verification is output (step S1006), and a series of the processing in this flowchart ends.

When the partial document IDs respectively added to the partial documents are not arranged in ascending order (step S1003: NO), a verification result indicating failure of the verification is output (step S1006), and a series of the processing in this flowchart ends.

Moreover, when not all of the partial documents are authentic (step S1004: NO), a verification result indicating failure of the verification is output (step S1006), and a series of the processing in this flowchart ends.

Thus, verification of authenticity of an extraction document can be performed even when an alteration such as a change in the order of partial documents constituting a digital document or copy thereof is made.

As described, with the document verification apparatus according to the first embodiment, even when an alteration such as a change of the order of partial documents constituting a digital document or copy thereof is made, authenticity of a digital document (extraction document) after the alteration is made can be verified.

Specifically, authenticity of each partial document can be determined based on a digital signature added to each partial document constituting the digital document. Moreover, by determining whether partial document IDs respectively added to the partial document constituting the digital document are arranged in ascending order (or descending order), a change of the order of the partial document in the digital document and copy thereof can be detected. Furthermore, by determining whether the document ID added to each partial document is consistent, authenticity of the digital document can be detected.

In a second embodiment of the present invention, the document verification apparatus calculates an aggregate digital signature in which digital signatures calculated for respective partial documents are aggregated, and performs verification of a digital document using this aggregate digital signature.

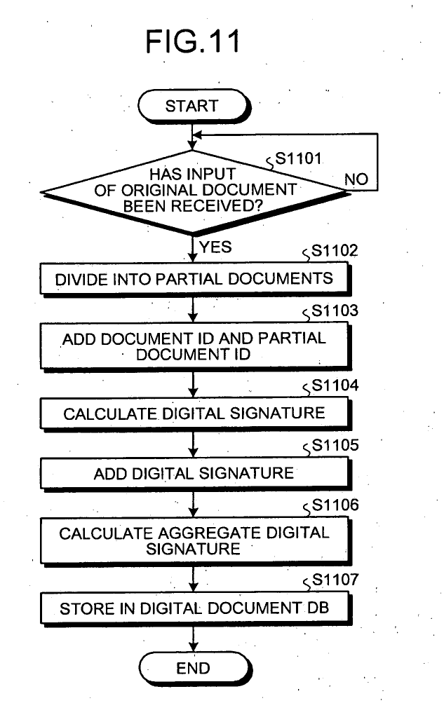

FIG. 11 is a flowchart of the digital signature creating processing performed by the document verification apparatus according to the second embodiment. As depicted in the flowchart in FIG. 11, the document verification apparatus first determines whether an input of an original document has been received (step S1101).

Waiting occurs until an original document is received, and when an original document is received (step S1101: YES), the input original document is divided into partial documents (step S1102). A document ID and a partial document ID are added to each of the partial documents obtained by the division (step S1103). Specifically, unpredictable random numbers are added as the document ID and the partial document ID. As for the partial document ID, a random number is added so that the random numbers are in ascending order according to the order in which the respective partial documents appear.

Next, a digital signature is calculated for each of the partial documents obtained at step S1102 (step S1104). The calculated digital signature is then added to each corresponding partial document (step S1105).

Subsequently, an aggregate digital signature in which the digital signatures that are calculated for the respective partial documents are aggregated is calculated (step S1106). Specifically, the aggregate digital signature is calculated by multiplying the digital signatures of the respective partial documents calculated at step S1104. For example, when the digital signatures of the respective partial documents calculated at step S1104 are “σ₁ to σ₅”, the aggregate digital signature σ is to be “σ=σ₁×σ₂×σ₃×σ₄×σ₅”.

Finally, the original document to which the digital signatures have been added is stored together with the aggregate digital signature calculated at step S1106 in the digital document DB (step S1107), and a series of processing in this flowchart ends.

The processing at step S1106 can be performed before adding the digital signature at step S1105, provided the processing is performed after the calculation of the digital signatures of the respective partial documents at step S1104.

Thus, verification of authenticity of an extraction document can be performed even when an alteration such as a change in the order of partial documents constituting a digital document or copy thereof is made.

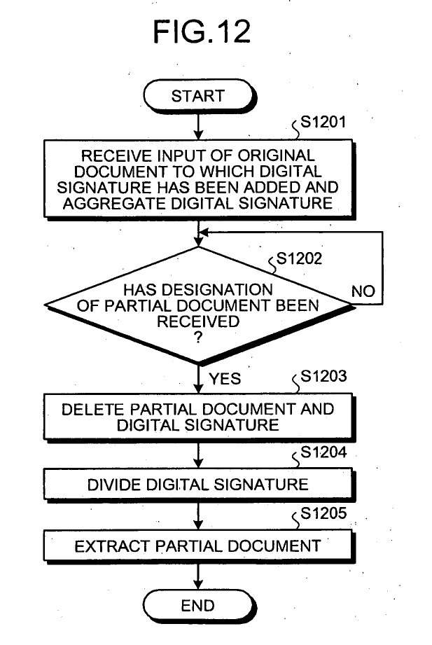

FIG. 12 is a flowchart of the digital document extraction processing performed by the document verification apparatus according to the second embodiment.

As depicted in FIG. 12, the document verification apparatus first receives an input of an original document to which a digital signature has been added (step S1201). Next, it is determined whether designation of an arbitrary partial document constituting the original document has received (step S1202).

Waiting occurs until designation of an arbitrary partial document is received, and when the designation is received (step S1202: YES), partial documents other than the designated partial document and the digital signatures added thereto are deleted (step S1203). Subsequently, the aggregate digital signature input at step S1201 is divided by the digital signatures added to the partial documents other than the designated partial document (step S1204).

Specifically, when the digital signatures added to the partial documents constituting the original document are “σ₁ to σ₅” and the digital signatures added to the designated partial documents are “σ₁, σ₃, σ₄, and σ₅”, the aggregate digital signature σ is divided by the digital signature “σ₂” added to the partial document that was not designated. In this case, the aggregate digital signature σ is “σ=σ₁×σ₃×σ₄×σ₅”.

Finally, the designated partial document is extracted from the original document (step S1205), and a series of processing in this flowchart ends. The processing at step S1203 and 1204 may be performed concurrently, or in reversed order.

Thus, an arbitrary partial document can be extracted from an original document by designating an arbitrary partial document in a digital document.

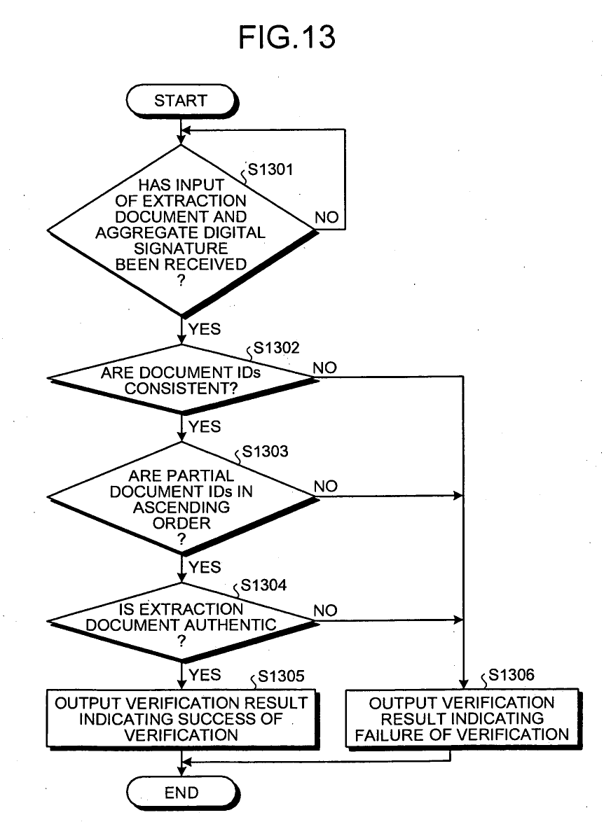

FIG. 13 is a flowchart of digital document verification processing performed by the document verification apparatus according to the second embodiment.

As depicted in FIG. 13, the document verification apparatus first determines whether an input of an extraction document and an aggregate digital signature has been received (step S1301). Waiting occurs until an extraction document and an aggregate digital signature are input, and when an input is received (step S1301: YES), it is determined whether the document IDs respectively added to the partial documents constituting the extraction document take an identical value (step S1302).

When the document IDs respectively added to the partial documents all take an identical value (step S1302: YES), it is determined whether the partial document IDs respectively added to the partial documents are arranged in ascending order (step S1303). Specifically, it is determined whether the value of the partial document ID added to each partial document increases in the order in which the partial documents constitute the extraction document.

When the partial document IDs respectively added to the partial documents are arranged in ascending order (step S1303: YES), the extraction document is verified based on the aggregate digital signature input at step S1301 (step S1304). Specifically, the authenticity of the extraction document is determined using the aggregate digital signature.

When the extraction document is verified to be authentic (step S1304: YES), a verification result indicating success of the verification of the extraction document is output (step S1305), and a series of processing in this flowchart ends.

When the document IDs respectively added to the partial documents do not take an identical value (step S1302: NO), a verification result indicating failure of the verification is output (step S1306), and a series of the processing in this flowchart ends.

When the partial document IDs respectively added to the partial documents are not arranged in ascending order (step S1303: NO), a verification result indicating failure of the verification is output (step S1306), and a series of the processing in this flowchart ends.

Moreover, when the extraction document is not verified (step S1304: NO), a verification result indicating failure of the verification is output (step S1306), and a series of the processing in this flowchart ends.

Thus, verification of authenticity of an extraction document can be performed even when an alteration such as a change in the order of partial documents constituting a digital document or copy thereof is made. Furthermore, by using an aggregate digital signature when the authenticity of an extraction document is determined, the digital document verification processing can be facilitated.

As described, with the document verification apparatus according to the second embodiment, even when an alteration such as a change of the order of partial documents constituting a digital document or a copy thereof is made, authenticity of a digital document (extraction document) after the alteration is made can be verified. Moreover, by using, when authenticity of a digital document is determined, an aggregate digital signature that is created for each digital document, the digital document verification processing can be facilitated.

In a third embodiment of the present invention, a property of forcible disclosure can be set to an arbitrary partial document among partial documents constituting a digital document. That is, a setting that enables specific information included in a digital document to be forcibly disclosed (disabling deletion) irrespective of intention of a user (extractor) can be made.

Since the procedure of the digital signature creating processing by the document verification apparatus is identical to that of the document verification apparatus according to the second embodiment, explanation thereof is omitted.

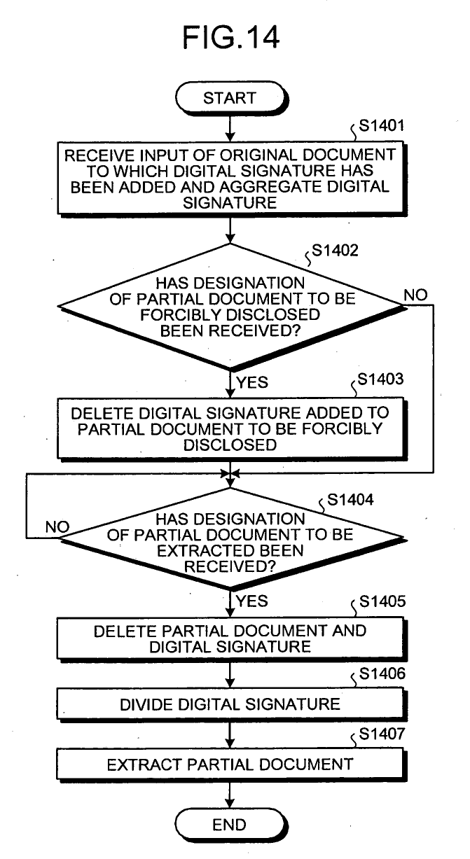

FIG. 14 is a flowchart of digital document extraction processing performed by the document verification apparatus according to the third embodiment.

As depicted in FIG. 14, the document verification apparatus first receives an input of an original document to which a digital signature has been added and an aggregate digital signature (step S1401). Next, it is determined whether designation of a partial document to be forcibly disclosed has been received (step S1402).

The partial document to be forcibly disclosed is a partial document that is forcibly extracted without designation by a user, and that cannot be deleted. If the designation of a partial document to be forcibly disclosed is received (step S1402: YES), the designated partial document is set as a partial document to be forcibly disclosed, and the digital signature that has been added to the partial document to be forcibly disclosed is deleted (step S1403).

Specifically, for example, the digital signatures “σ₁to σ₅” have been added to partial documents “partial document 1 to partial document 5” constituting the original document. If the partial document 4 is designated as the partial document to be forcibly disclosed, the digital signature “σ₄” added to the partial document 4 is deleted.

The partial document that is set as the partial document to be forcibly disclosed is to be forcibly extracted (forcibly disclosed) without designation as an extracted partial document by a current user and if the digital document extraction processing is performed by a subsequent user.

Next, it is determined whether designation of a partial document to be extracted has been received (step S1404). Waiting occurs until designation of a partial document to be extracted is received, and when the designation is received (step S1404: YES), a digital signature that has been added to a partial document other than the designated partial document, both the partial document and the digital signature added thereto are deleted (step S1405). When the designation of a partial document to be forcibly disclosed is not received (step S1402: NO), the process proceeds to step S1404.

The partial document that has been designated as a partial document to be forcibly disclosed at step S1402 is not deleted even if the partial document has not been designated as an extraction document at step S1404. The digital signature that has been added to the partial document to be forcibly disclosed is deleted at step S1403.

Next, the aggregate digital signature input at step S1401 is divided by the digital signature added to a partial document other than the designated partial document (step S1406). Specifically, when the aggregate digital signature is “σ=σ₁×σ₂×σ₃×σ₄×σ₅” and the digital signature that has been added to the partial document (partial document 2 to be deleted) other than the designated digital document is “σ₂”, the aggregate digital signature σ is “σ=σ₁×σ₃×σ₄×σ₅”. The aggregate digital signature σ is not divided by the digital signature σ₄ added to the partial document 4 that is designated as a partial document to be forcibly disclosed.

Finally, the partial document designated at step S1404 is extracted from the original document (step S1407), and a series of the processing in this flowchart ends.

As described, by designating an arbitrary partial document in a digital document, an arbitrary partial document can be extracted from the digital document. In addition, by setting a partial document to be forcibly disclosed, deletion of the partial document is disabled (forcibly extracted) in the digital document extraction processing performed subsequently.

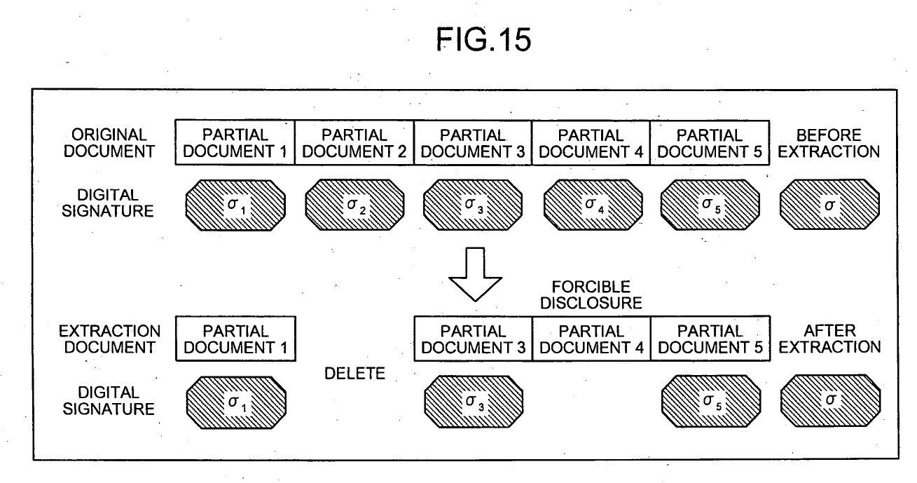

FIG. 15 is a schematic of an example of an original document and an extraction document in which a partial document to be forcibly disclosed is set. As depicted in FIG. 15, to the partial documents 1 to 5 constituting an original document, the digital signatures σ₁ to σ₅ have been added, respectively. The aggregate digital signature σ is expressed by a product of the digital signatures σ₁ to σ₅.

When the partial document 4 is set as a partial document to be forcibly disclosed in this state, the digital signature σ₄ that has been added to the partial document 4 is deleted. When the partial document 1, the partial document 2, and the partial document 5 are further designated as partial documents to be extracted, the partial document 2, which has not been designated as an extraction document or as a partial document to be forcibly disclosed, is deleted together with the digital signature σ2 added to the partial document 2.

As a result, the partial documents to be extracted from the original document include the partial document 1, the partial document 3, the partial document 4, and the partial document 5. The aggregate digital signature in this case is “σ=σ₁×σ₃×σ₄×σ₅”, which is obtained by dividing by the digital signature σ₂, which had been added to the partial document 2 designated for deletion.

Since digital document verification processing performed by a document verification apparatus according to the third embodiment is substantially identical to that performed by the document verification apparatus according to the second embodiment, only differing points are explained.

In addition to the digital document verification processing performed by the document verification apparatus according to the second embodiment, configuration may include a process of determining the authenticity of an extraction document based on a digital signature added to each partial document constituting an input extraction document.

Specifically, before the processing at step S1304 in the flowchart depicted in FIG. 13, for example, the process of determining the authenticity of each partial document constituting a digital document based on a digital signature added to each partial document is added. the authenticity of a partial document is determined based on the digital signature of each partial document, and if even one partial document on which an improper alteration has been made is present, a verification result indicating failure of verification is output.

Even when this process is added, the digital signature added to the partial document to be forcibly disclosed is deleted, and therefore, verification of this partial document to be forcibly disclosed is not performed. Accordingly, the digital signature added to the partial document to be forcibly disclosed does not affect the digital document verification processing, and digital document verification processing can be conducted normally.

Thus, verification of authenticity of an extraction document can be performed even when an alteration such as a change in the order of partial documents constituting a digital document or copy thereof is made.

As described, with the document verification apparatus according to the third embodiment, even when an alteration such as a change of the order of partial documents constituting a digital document or a copy thereof is made, authenticity of a digital document (extraction document) after the alteration is made can be verified. Moreover, by setting a partial document to be forcibly disclosed, deletion of the partial document can be prohibited (forced extraction) during subsequent digital document extraction processing.

The document verification method explained in the present embodiments can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium storing therein a computer program that causes a computer to execute:
receiving an input of a first digital document;
dividing arbitrarily the first digital document into constituent parts; and
assigning a random number to each of the constituent parts according to an order in which the constituent parts appear in the first digital document, the random number being a normal random number or a pseudo random number.

2. The computer-readable recording medium according to claim 1, wherein
the assigning includes assigning a common random number to each of the constituent parts, the common random number being a normal random number or a pseudo random number.

3. The computer-readable recording medium according to claim 1 further causing the computer to execute:
generating a digital signature for each of the constituent parts; and
setting a digital signature generated at the generating to a corresponding constituent part among the constituent parts.

4. The computer-readable recording medium according to claim 1 further causing the computer to execute:
receiving arbitrary designation of constituent parts constituting the first digital document; and
extracting, from the first digital document, the constituent parts designated.

5. The computer-readable recording medium according to claim 4 further causing the computer to execute:
receiving a second digital document that is constituted of the constituent parts extracted at the extracting;
determining whether random numbers respectively assigned to the constituent parts of the second digital document are in accordance with the order in which the constituent parts appear in the second digital document;
verifying authenticity of the second digital document based on a result of determination made at the determining; and
outputting a result of verification at the verifying.

6. The computer-readable recording medium according to claim 5 further causing the computer to execute:
generating a digital signature for each of the constituent parts of the first digital document; and
setting a digital signature generated at the generating to a corresponding constituent part among the constituent parts of the first digital document, wherein
the determining includes determining, based on the digital signature set to each of the constituent parts extracted at the extracting, authenticity of each of the constituent parts extracted at the extracting.

7. The computer program according to claim 5, wherein
the assigning includes assigning a common random number to each of the constituent parts of the first digital document, the common random number being a normal random number or a pseudo random number, and
the determining includes determining whether the common random number assigned to each of the constituent parts at the assigning is consistent among the constituent parts extracted at the extracting.

8. The computer-readable recording medium according to claim 5 further causing the computer to execute:
generating a digital signature for each of the constituent parts of the first digital document; and
setting a digital signature generated at the generating to a corresponding constituent part among the constituent parts of the first digital document, wherein
the generating includes generating an aggregate digital signature in which respective digital signatures of the constituent parts are aggregated, and
the determining includes determining authenticity of the second digital document based on the aggregate digital signature.

9. The computer-readable recording medium according to claim 4 further causing the computer to execute:
generating a digital signature for each of the constituent parts of the first digital document; and
setting a digital signature generated at the generating to a corresponding constituent part among the constituent parts of the first digital document;
receiving designation of a partial document that is to be forcibly disclosed and is among the constituent parts constituting the first digital document; and
deleting a digital signature set to the constituent part designated to be forcibly disclosed, wherein
the generating includes generating an aggregate digital signature in which respective digital signatures of the constituent parts are aggregated.

10. A document verifying method comprising:
receiving an input of a digital document;
dividing arbitrarily the digital document into constituent parts; and
assigning a random number to each of the constituent parts according to an order in which the constituent parts appear in the digital document, the random number being a normal random number or a pseudo random number.

11. A document verifying apparatus comprising:
a receiving unit that receives an input of a digital document;
a dividing unit that arbitrarily divides the digital document into constituent parts; and
an assigning unit that assigns a random number to each of the constituent parts according to an order in which the constituent parts appear in the digital document, the random number being a normal random number or a pseudo random number.
